(19) United States
(12) Patent Application Publication
(10) Pub. No.: US 2008/0246757 A1
(43) Pub. Date: Oct. 9, 2008

(54) 3D Image Generation and Display System

(76) Inventor: Masahiro Ito, Tokyo (JP)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/912,669

(22) PCT Filed: Apr. 25, 2005
(86) PCT No.: PCT/JP2005/008335

§ 371 Date: Jun. 9, 2008

(51) Int. Cl. G06T 15/00

(52) U.S. Cl. 345/419

(57) ABSTRACT

A 3D image generation and display system facilitating the display of high-quality images in a Web browser comprises means for creating 3D images from a plurality of different images and computer graphics modeling and generating a 3D object from these images that has texture and attribute data; means for converting and outputting the 3D object as a 3D description file in a 3D graphics descriptive language; means for extracting a 3D object and textures from the 3D description file, setting various attribute data, and editing and processing the 3D object to introduce animation or the like and assigning various effects; means for generating various Web-based 3D objects from the 3D data files produced above that are compressed to be displayed in a Web browser and generating behavior data to display 3D scenes in a Web browser with animation; and means for generating an executable file comprising a Web page and Web-based programs such as scripts, plug-ins, and applets for drawing and displaying 3D scenes in a Web browser.

### CROSS-REFERENCE TO RELATED APPLICATIONS

The present Application is based on International Application No. PCT/JP2005/008335, filed on Apr. 25, 2005, and priority is hereby claimed under 35 USC §119 based on this application. This application is hereby incorporated by reference in its entirety.

### TECHNICAL FIELD

The present invention relates to a 3D image generation and display system that generates a three-dimensional (3D) object for displaying various photographic images and computer graphics models in 3D, and for editing and processing the 3D objects for drawing and displaying 3D scenes in a Web browser.

### BACKGROUND ART

There are various systems well known in the art for creating 3D objects used in 3D displays. One such technique that uses a 3D scanner for modeling and displaying 3D objects is the light-sectioning method (implemented by projecting a slit of light) and the like well known in the art. This method performs 3D modeling using a CCD camera to capture points or lines of light projected onto an object by a laser beam or other light source, and measuring the distance from the camera using the principles of triangulation.

FIG. 13(a) is a schematic diagram showing a conventional 3D modeling apparatus employing light sectioning.

A CCD camera captures images when a slit of light is projected onto an object from a light source. By scanning the entire object being measured while gradually changing the direction in which the light source projects the slit of light, an image such as that shown in FIG. 13(b) is obtained. 3D shape data is calculated according to the triangulation method from the known positions of the light source and camera. However, since the entire periphery of the object cannot be rendered in three dimensions with the light-sectioning method, it is necessary to collect images around the entire periphery of the object by providing a plurality of cameras, as shown in FIG. 14, so that the object can be imaged with no hidden areas.

Further, the 3D objects created through these methods must then be subjected to various effects applications and animation processes for displaying the 3D images according to the desired use, as well as various data processes required for displaying the objects three-dimensionally in a Web browser. For example, it is necessary to optimize the image by reducing the file size or the like to suit the quality of the communication line.

One type of 3D image display is a liquid crystal panel or a display used in game consoles and the like to display 3D images in which objects appear to jump out of the screen. This technique employs special glasses such as polarizing glasses with a different direction of polarization in the left and right lenses. In this 3D image displaying device, left and right images are captured from the same positions as when viewed with the left and right eyes, and polarization is used so that the left image is seen only with the left eye and the right image only with the right eye. Other examples include devices that use mirrors or prisms. However, these 3D image displays have the complication of requiring viewers to wear glasses and the like. Hence, 3D image displaying systems using lenticular lenses, a parallax barrier, or other devices that allow a 3D image to be seen without glasses have been developed and commercialized. One such device is a “3D image signal generator” disclosed in Patent Reference 1 (Japanese unexamined patent application publication No. H10-271533). This device improved the 3D image display disclosed in U.S. Pat. No. 5,410,345 (Apr. 25, 1995) by enabling the display of 3D images on a normal LCD system used for displaying two-dimensional images.

FIG. 15 is a schematic diagram showing this 3D image signal generator. The 3D image signal generator includes a backlight 1 including light sources 12 disposed to the sides in a side lighting method; a lenticular lens 15 capable of moving in the front-to-rear direction; a diffuser 5 for slightly diffusing incident light; and an LCD 6 for displaying an image. As shown in a stereoscopic display image 20 in FIG. 16, the LCD 6 has a structure well known in the art in which pixels P displaying each of the colors R, G, and B are arranged in a striped pattern. A single pixel Pk, where k=0−n, is configured of three sub-pixels for RGB arranged horizontally. The color of the pixel is displayed by mixing the three primary colors displayed by each sub-pixel in an additive process.

When displaying a 3D image with the backlight 1 shown in FIG. 15, the lenticular lens 15 makes the sub-pixel array on the LCD 6 viewed from a right eye 11 appear differently from a sub-pixel array viewed from a left eye 10. To describe this phenomenon based on the stereoscopic display image 20 of FIG. 16, the left eye 10 can only see sub-pixels of even columns 0, 2, 4, . . . , while the right eye 11 can only see sub-pixels of odd columns 1, 3, 5, . . . . Hence, to display a 3D image, the 3D image signal generator generates a 3D image signal from image signals for the left image and right image captured at the positions of the left and right eyes and supplies these signals to the LCD 6.

As shown in FIG. 16, the stereoscopic display image 20 is generated by interleaving RGB signals from a left image 21 and a right image 22. With this method, the 3D image signal generator configures rgb components of a pixel P0 in the 3D image signal from the r and b components of the pixel P0 in the left image signal and the g component of the pixel P0 in the right image signal, and configures rgb components of a pixel P1 in the 3D image signal (center columns) from the g component of the pixel P1 in the left image signal and the r and b components of the pixel P1 in the right image signal. With this interleaving process, normally rgb components of a k^{th} (where k is 1, 2, . . . ) pixel in the 3D image signal are configured of the r and b components of the k^{th} pixel in the left image signal and the g component of the k^{th} pixel in the right image signal, and the rgb components of the k+1^{th} image pixel in the 3D image signal are configured of the g component of the k+1^{th} pixel in the left image signal and the r and b components of the k+1^{th} pixel in the right image signal.

The 3D image signals generated in this method can display a 3D image compressed to the same number of pixels in the original image. Since the left eye can only see sub-pixels in the LCD 6 displayed in even columns, while the right eye can only see sub-pixels displayed in odd columns, as shown in FIG. 18, a 3D image can be displayed. In addition, the display can be switched between a 3D and 2D display by adjusting the position of the lenticular lens 15.

While the example described above in FIG. 15 has the lenticular lens 15 arranged on the back surface of the LCD 6, a “stereoscopic image display device” disclosed in patent reference 2 (Japanese unexamined patent application publication No. H11-72745) gives an example of a lenticular lens disposed on the front surface of an LCD. As shown in FIG. 19, the stereoscopic image display device has a parallax barrier (a lenticular lens is also possible) 26 disposed on the front surface of an LCD 25. In this device, pixel groups 27R, 27G, and 27B are formed from pairs of pixels for the right eye (Rr, Gr, and Br) driven by image signals for the right eye, and pixels for the left eye (RL, GL, and BL) driven by image signals for the left eye. By arranging two left and right cameras to photograph an object at left and right viewpoints corresponding to the left and right eyes of a viewer, two parallax signals are created. The example in FIGS. 20(a) and 20(b) show R and L signals created for the same color. A means for compressing and combining these signals is used to rearrange the R and L signals in an alternating pattern (R, L, R, L, . . . ) to form a single stereoscopic image, as shown in FIG. 20(c). Since the combined right and left signals must be compressed by half, the actual signal for forming a single stereoscopic image is configured of pairs of image data in different colors for the left and right eyes, as shown in FIG. 20(d). In this example, the display is switched between 2D and 3D by switching the slit positions in the parallax barrier.

Patent reference 1: Japanese unexamined patent application publication No. H10-271533

Patent reference 2: Japanese unexamined patent application publication No. H11-72745

### DISCLOSURE OF THE INVENTION

### Problems to be Solved by the Invention

However, the 3D scanning method illustrated in FIGS. 13 and 14 uses a large volume of data and necessitates many computations, requiring a long time to generate the 3D object. In addition, the device is complex and expensive. The device also requires special expensive software for applying various effects and animation to the 3D object.

Therefore, it is one object of the present invention to provide a 3D image generation and display system that uses a 3D scanner employing a scanning table method for rotating the object, in place of the method of collecting photographic data through a plurality of cameras disposed around the periphery of the object, in order to generate precise 3D objects based on a plurality of different images in a short amount of time and with a simple construction. This 3D image generation and display system generates a Web-specific 3D object using commercial software to edit and process the major parts of the 3D object in order to rapidly draw and display 3D scenes in a Web browser.

In the stereoscopic image devices shown in FIGS. 15-20, the format of the left and right parallax signals differs when the format of the display devices differ, as in the system for switching between 2D and 3D displays when using the same liquid crystal panel by moving the lenticular lens shown in FIG. 15 and the system for fixing the parallax barrier shown in FIG. 19. In the same way, the format of the left and right parallax signals differs for all display devices having different formats, such as the various display panels, CRT screens, 3D shutter glasses, and projectors.

The format of the left and right parallax signals also differs when using different image signal formats, such as the VGA method or the method of interlacing video signals.

Further, in the conventional technology illustrated in FIGS. 15-20, the left and right parallax signals are created from two photographic images taken by two digital cameras positioned to correspond to left and right eyes. However, the format and method of generating left and right parallax data differs when the format of the original image data differs, such as when creating left and right parallax data directly using left and right parallax data created by photographing an object and character images created by computer graphics modeling or the like.

Therefore, it is another object of the present invention to provide a 3D image generation and display system for creating 3D images that generalize the format of left and right parallax signals where possible to create a common platform that can assimilate various input images and differences in signal formats of these input images, as well as differences in the various display devices, and for displaying these 3D images in a Web browser.

### Means for Solving the Problems

To attain these objects, a 3D image generation and display system according to claim 1 is configured of a computer system for generating three-dimensional (3D) objects used to display 3D images in a Web browser, the 3D image generation and display system comprising 3D object generating means for creating 3D images from a plurality of different images and/or computer graphics modeling and generating a 3D object from these images that has texture and attribute data; 3D description file outputting means for converting the format of the 3D object generated by the 3D object generating means and outputting the data as a 3D description file for displaying 3D images according to a 3D graphics descriptive language; 3D object processing means for extracting a 3D object from the 3D description file, setting various attribute data, editing and processing the 3D object to introduce animation or the like, and outputting the resulting data again as a 3D description file or as a temporary file for setting attributes; texture processing means for extracting textures from the 3D description file, editing and processing the textures to reduce the number of colors and the like, and outputting the resulting data again as a 3D description file or as a texture file; 3D effects applying means for extracting a 3D object from the 3D description file, processing the 3D object and assigning various effects such as lighting and material properties, and outputting the resulting data again as a 3D description file or as a temporary file for assigning effects; Web 3D object generating means for extracting various elements required for rendering 3D images in a Web browser from the 3D description file, texture file, temporary file for setting attributes, and temporary file for assigning effects, and for generating various Web-based 3D objects having texture and attribute data that are compressed to be displayed in a Web browser; behavior data generating means for generating behavior data to display 3D scenes in a Web browser with animation by controlling attributes of the 3D objects and assigning effects; and executable file generating means for generating an executable file comprising a Web page and one or a plurality of programs including scripts, plug-ins, and applets for drawing and displaying 3D scenes in a Web browser with stereoscopic images produced from a plurality of combined images assigned with a prescribed parallax, based on the behavior data and the Web 3D objects generated, edited, and processed by the means described above.

Further, a 3D object generating means according to claim 2 comprises a turntable on which an object is mounted and rotated either horizontally or vertically; a digital camera for capturing images of an object mounted on the turntable and creating digital image files of the images; turntable controlling means for rotating the turntable to prescribed positions; photographing means using the digital camera to photograph an object set in prescribed positions by the turntable controlling means; successive image creating means for creating successively creating a plurality of image files using the turntable controlling means and the photographing means; and 3D object combining means for generating 3D images based on the plurality of image files created by the successive image creating means and generating a 3D object having texture and attribute data from the 3D images for displaying the images in 3D.

Further, the 3D object generating means according to claim 3 generates 3D images according to a silhouette method that estimates the three-dimensional shape of an object using silhouette data from a plurality of images taken by a single camera around the entire periphery of the object as the object is rotated on the turntable.

Further, the 3D object generating means according to claim 4 generates a single 3D image as a composite scene obtained by combining various image data, including images taken by a camera, images produced by computer graphics modeling, images scanned by a scanner, handwritten images, image data stored on other storage media, and the like.

Further, the executable file generating means according to claim 5 comprises automatic left and right parallax data generating means for automatically generating left and right parallax data for drawing and displaying stereoscopic images according to a rendering function based on right eye images and left eye images assigned a parallax from a prescribed camera position; parallax data compressing means for compressing each of the left and right parallax data generated by the automatic left and right parallax data generating means; parallax data combining means for combining the compressed left and right parallax data; parallax data expanding means for separating the combined left and right parallax data into left and right sections and expanding the data to be displayed on a stereoscopic image displaying device; and display data converting means for converting the data to be displayed according to the angle of view (aspect ratio) of the stereoscopic image displaying device.

Further, the automatic left and right parallax data generating means according to claim 6 automatically generates left and right parallax data corresponding to a 3D image generated by the 3D object generating means based on a virtual camera set by a rendering function.

Further, the parallax data compressing means according to claim 7 compresses pixel data for left and right parallax data by skipping pixels.

Further, the stereoscopic display device according to claim 8 employs at least one of a CRT screen, liquid crystal panel, plasma display, EL display, and projector.

Further, the stereoscopic display device according to claim 9 displays stereoscopic images that a viewer can see when wearing stereoscopic glasses or displays stereoscopic images that a viewer can see when not wearing glasses.

### EFFECTS OF THE INVENTION

The 3D image generation and display system of the present invention can configure a computer system that generates 3D objects to be displayed on a 3D display. The3D image generation and display system has a simple construction employing a scanning table system to model an object placed on a scanning table by collecting images around the entire periphery of the object with a single camera as the turntable is rotated. Further, the 3D image generation and display system facilitates the generation of high-quality 3D objects by taking advantage of common software sold commercially.

The 3D image generation and display system can also display animation in a Web browser by installing a special plug-in for drawing and displaying 3D scenes in a Web browser or by generating applets for effectively displaying 3D images in a Web browser.

The 3D image generation and display system can also constitute a display program capable of displaying stereoscopic images according to LR parallax image data, 3D images of the kind that do not “jump out” at the viewer, and common 2D images on the same display device.

### BEST MODE FOR CARRYING OUT THE INVENTION

Next, a preferred embodiment of the present invention will be described while referring to the accompanying drawings.

FIG. 1 is a flowchart showing steps in a process performed by a 3D image generation and display system according to a first embodiment of the present invention.

In the process of FIG. 1 described below, a 3D scanner described later is used to form a plurality of 3D images. A 3D object is generated from the 3D images and converted to the standard Virtual Reality Modeling Language (VRML; a language for describing 3D graphics) format. The converted 3D object in the outputted VRML file is subjected to various processes for producing a Web 3D object and a program file that can be executed in a Web browser.

First, a 3D scanner of a 3D object generating means employing a digital camera captures images of a real object, obtaining twenty-four 3D images taken at varying angles of 15 degrees, for example (S101). The 3D object generating means generates a 3D object from these images and 3D description file outputting means converts the 3D object temporarily to the VRML format (S102). 3D ScanWare (product name) or a similar program can be used for creating 3D images, generating 3D objects, and producing VRML files.

The 3D object generated with a 3D authoring software (such as a software mentioned below) is extracted from the VRML file and subjected to various editing and processing by 3D object processing means (S103). The commercial product “3ds max” (product name) or other software is used to analyze necessary areas of the 3D object to extract texture images, to set required attributes for animation processes and generate various 3D objects, and to setup various animation features according to need. After undergoing editing and processing, the 3D object is saved again as a 3D description file in the VRML format or is temporarily stored in a storage device or area of memory as a temporary file for setting attributes. In the animation settings, the number of frames or time can be set in key frame animation for moving an object provided in the 3D scene at intervals of a certain number of frames. Animation can also be created using such techniques as path animation and character studio for creating a path, such as a Nurbs CV curve, along which an object is to be moved. Using texture processing means, the user extracts texture images applied to various objects in the VRML file, edits the texture images for color, texture mapping, or the like, reduces the number of colors, modifies the region and location/position where the texture is applied, or performs other processes, and saves the resulting data as a texture file (S104). Texture editing and processing can be done using commercial image editing software, such as Photoshop (product name).

3D effects applying means are used to extract various 3D objects from the VRML file and to use the extracted objects in combination with 3ds max or similar software and various plug-ins in order to process the 3D objects and apply various effects, such as lighting and material properties. The resulting data is either re-stored as a 3D description file in the VRML format or saved as a temporary file for applying effects (S105). In the description thus far, the 3D objects have undergone processes to be displayed as animation on a Web page and processes for reducing the file size as a pre-process in the texture image process or the like. The following steps cover processes for reducing and optimizing the object size and file size in order to actually display the objects in a Web browser.

Web 3D object generating means extracts 3D objects, texture images, attributes, animation data, and other rendering elements from the VRML and temporary files created during editing and processing and generates Web 3D objects for displaying 3D images on the Web (S106). At the same time, behavior data generating means generates behavior data as a scenario for displaying the Web 3D object as animation (S107). Finally, executable file generating means generates an executable file in the form of plug-in software for a Web browser or a program combining a Java Applet, Java Script, and the like to draw and display images in a Web browser based on the above data for displaying 3D images (S108).

By using the VRML format, which is supported by most 3D software programs, it is possible to edit and process 3D images using an all-purpose commercial software program. The system can also optimize the image for use on the Web based on the transfer rate of the communication line or, when displaying images on a Web browser of a local computer, can edit and process the images appropriately according to the display environment, thereby controlling image rendering to be effective and achieve optimal quality in the display environment.

FIG. 2 is a schematic diagram showing the 3D object generating means of the 3D image generation and display system described above with reference to FIG. 1.

The Web 3D object generating means in FIG. 2 includes a turntable 31 that supports an object 33 (corresponding to the “object” in the claims section and referred to as an “object” or “real object” in this specification) and rotates 360 degrees for scanning the object 33; a background panel 32 of a single primary color, such as green or blue; a digital camera 34, such as a CCD; lighting 35; a table rotation controller 36 that rotates the turntable 31 through servo control; photographing means 37 for controlling and calibrating the digital camera 34 and lighting 35, performing gamma correction and other image processing of image data and capturing images of the object 33; and successive image creating means 38 for controlling the angle of table rotation and sampling and collecting images at prescribed angles. These components constitute a 3D modeling device employing a scanning table and a single camera for generating a series of images viewed from a plurality of angles. At this point, the images are modified according to need using commercial editing software such as AutoCAD and STL (product names). A 3D object combining means 39 extracts silhouettes from the series of images and creates 3D images using a silhouette method or the like to estimate 3D shapes in order to generate 3D object data.

Next, the operations of the 3D image generation and display system will be described.

In the silhouette method, the camera is calibrated by calculating, for example, correlations between the world coordinate system, camera coordinate system, and image coordinate system. The points in the image coordinate system are converted to points in the world coordinate system in order to process the images in software.

After calibration is completed, the successive image creating means 38 coordinates with the table rotation controller 36 to control the rotational angle of the turntable for a prescribed number of scans (scanning images every 10 degrees for 36 scans or every 5 degrees for 72 scans, for example), while the photographing means 37 captures images of the object 33. Silhouette data of the object 33 is acquired from the captured images by obtaining a background difference, which is the difference between images of the background panel 32 taken previously and the current camera image. A silhouette image of the object is derived from the background difference and camera parameters obtained from calibration. 3D modeling is then performed on the silhouette image by placing a cube having a recursive octal tree structure in a three-dimensional space, for example, and determining intersections in the silhouette of the object.

FIG. 3 is a flowchart that gives a more specific/concrete example—which is in accordance with steps in the process for converting 3D images shown in FIG. 1—so that the steps shown in FIG. 1 can be better/further explained. The process in FIG. 3 is implemented by a Java Applet that can display 3D images in a Web browser without installing a plug-in for a viewer, such as Live 3D. In this example, all the data necessary for displaying interactive 3D scenes is provided on a Web server. The 3D scenes are displayed when the server is accessed from a Web browser running on a client computer. Normally, after 3D objects are created, 3ds max or the like is used to modify motion, camera, lighting, and material properties and the like in the generated 3D objects. However, in the preferred embodiment, the 3D objects or the entire scene is first converted to the VRML format (S202).

The resulting VRML file is inputted into a 3DA system (S203; here, 3DA describes 3D images that are displayed as animation on a Web browser using a Java Applet, and the entire system including the authoring software for Web-related editing and processing is called a 3DA system). The 3D scene is customized, and data for rendering the image with the 3DA applet is provided for drawing and displaying the 3D scene in the Web browser (S205). All 3D scene data is compressed at one time and saved as a compressed 3DA file (S206). The 3DA system generates a tool bar file for interactive operations and an HTML file, where the HTML page reads the tool bar file into the Web browser, so that the tool bar file is executed, and that 3D scenes are displayed in a Web browser. (S207).

The new Web page (HTML document) includes an applet tag for calling the 3DA applet. Java Script code for accessing the 3DA applet may be added to the HTML document to improve operations and interactivity (S209). All files required for displaying the 3D scene created as described above are transferred to the Web server. These files include the Web page (HTML document) possessing the applet tag for calling the 3DA applet, a tool bar file for interactive operations as an option, texture image files, 3DA scene files, and the 3DA applet for drawing and displaying 3D scenes (S210).

When a Web browser subsequently connects to the Web server and requests the 3DA applet, the Web browser downloads the 3DA applet from the Web server and executes the applet (S211). Once the 3DA applet has been executed, the applet displays a 3D scene with which the user can perform interactive operations, and the Web browser can continue displaying the 3D scene independently of the Web server (S212).

In the process described to this point, a 3DA Java applet file is generated after converting the 3D objects to the Web-based VRML, and the Web browser downloads the 3DA file and 3DA applet. However, rather than generating a 3DA file, it is of course possible to install a plug-in for a viewer, such as Live 3D (product name) and process the VRML 3D description file directly. With the 3D image generation and display system of the preferred embodiment, a company can easily create a Web site using three-dimensional and moving displays of products for e-commerce and the like.

As an example of an e-commerce product, the following description covers the starting of a commercial Web site for printers, such as that shown in FIG. 4.

First, the company's product, a printer 60 as the object 33, is placed on the turntable 31 shown in FIG. 2 and rotated, while the photographing means 37 captures images at prescribed sampling angles. The successive image creating means 38 sets the number of images to sample, so that the photographing means 37 captures thirty-six images assuming a sampling angle of 10 degrees (360 degrees/10 degrees=36). The 3D object combining means 39 calculates the background difference between the camera position and the background panel 32 that has been previously photographed and converts image data for each of the thirty-six images of the printer created by the successive image creating means 38 to world coordinates by coordinate conversion among world coordinates, camera coordinates, and image positions. The silhouette method for extracting contours of the object is used to model the outer shape of the printer and generate a 3D object of the printer. This object is temporarily outputted as a VRML file. At this time, all 3D images to be displayed on the Web are created, including a rear operating screen, left and right side views, top and bottom views, a front operating screen, and the like.

Next, as described in FIG. 1, the 3D object processing means, texture processing means, and 3D effects applying means extract the generated 3D image data from the VRML file, analyze relevant parts of the data, generate 3D objects, apply various attributes, perform animation processes, and apply various effects and other processes, such as lighting and surface formation through color, material, and texture mapping properties. The resulting data is saved as a texture file, a temporary file for attributes, a temporary file for effects, and the like. Next, the behavior data generating means generates data required for movement in all 3D description files used on the printer Web site. Specifically, the behavior data generating means generates a file for animating the actual operating screen in the setup guide or the like.

By installing a plug-in in the Web browser for a viewer, such as Live 3D, the 3D scene data created above can be displayed in the Web browser. It is also possible to use a method for processing the 3D scene data in the Web browser only, without using a viewer. In this case, a 3DA file for a Java applet is downloaded to the Web browser for drawing and displaying the 3D scene data extracted from the VRML file, as described above.

When viewing the Web site created above displaying a 3D image of the printer, the user can operate a mouse to click on items in a setup guide menu displayed in the browser to display an animation sequence in 3D. This animation may illustrate a series of operations that rotate a button 63 on a cover 62 of the printer 60 to detach the cover 62 and install a USB connector 66.

When the user clicks on “Install Cartridge” in the menu, a 3D animation sequence will be played in which the entire printer is rotated to show the front surface thereof (not shown in the drawings). A top cover 61 of the printer 60 is opened, and a cartridge holder in the printer 60 moves to a center position. Black and color ink cartridges are inserted into the cartridge holder, and the top cover 61 is closed.

Further, if the user clicks on “Maintenance Screen,” a 3D image is displayed in which all of the plastic covers have been removed to expose the inner mechanisms of the printer (not shown). In this way, the user can clearly view spatial relationships among the driver module, scanning mechanism, ink cartridges, and the like in three dimensions, facilitating maintenance operations.

By displaying operating windows with 3D animation in this way, the user can look over products with the same sense of reality as when actually operating the printer in a retail store.

While the above description is a simple example for viewing printer operations, the 3D image generation and display system can be used for other applications, such as trying on apparel. For example, the 3D image generation and display system can enable the user to try on a suit from a women's clothing store or the like. The user can click on a suit worn by a model; change the size and color of the suit; view the modeled suit from the front, back, and sides; modify the shape, size, and color of the buttons; and even order the suit by e-mail. Various merchandise, such as sculptures or other fine art at auctions and everyday products, can also be displayed in three-dimensional images that are more realistic than two-dimensional images.

Next, a second embodiment of the present invention will be described while referring to the accompanying drawings.

FIG. 5 is a schematic diagram showing a 3D image generation and display system according to a second embodiment of the present invention. The second embodiment further expands the 3D image generation and display system to allow the 3D images generated and displayed on a Web page in the first embodiment to be displayed as stereoscopic images using other 3D display devices.

The 3D image generation and display system in FIG. 5 includes a turntable-type 3D object generator 71 identical to the 3D object generating means of the first embodiment shown in FIG. 2. This 3D object generator 71 produces a 3D image by combining images of an object taken with a single camera while the object is rotated on a turntable. The 3D image generation and display system of the second embodiment also includes a multiple camera 3D object generator 72. Unlike the turntable-type 3D object generator 71, the 3D object generator 72 generates 3D objects by arranging a plurality of cameras from two stereoscopic cameras corresponding to the positions of left and right eyes to n cameras (while not particularly limited to any number, a more detailed image can be achieved with a larger number of cameras) around a stationary object. The 3D image generation and display system also includes a computer graphics modeling 3D object generator 73 for generating a 3D object while performing computer graphics modeling through the graphics interface of a program, such as 3ds max. The 3D object generator 73 is a computer graphics modeler that can combine scenes with computer graphics, photographs, or other data.

After performing the processes of S103-S107 described in FIG. 1 of the first embodiment to save 3D objects produced by the 3D object generators 71-73 temporarily as general-purpose VRML files, 3D scene data is extracted from the VRML files using a Web authoring tool, such as YAPPA 3D Studio (product name). The authoring software is used to edit and process the 3D objects and textures; add animation; apply, set, and process other effects, such as camera and lighting effects; and generate Web 3D objects and their behavior data for drawing and displaying interactive 3D images in a Web browser. An example for creating Web 3D files was described in S202-S210 of FIG. 3.

Means 75-79 are parts of the executable file generating means used in S108 of FIG. 1 that apply left and right parallax data for displaying stereoscopic images. A renderer 75 applies rendering functions to generate left and right parallax images (LR data) required for displaying stereoscopic images. An LR data compressing/combining means 76 compresses the LR data generated by the renderer 75, rearranges the data in a combining process and stores the data in a display frame buffer. An LR data separating/expanding means 77 separates and expands the left and right data when displaying LR data. A data converting means 78 configured of a down converter or the like adjusts the angle of view (aspect ratio and the like) for displaying stereoscopic images so that the LR data can be made compatible with various 3D display devices. A stereoscopic displaying means 79 displays stereoscopic images based on the LR data and using a variety of display devices, such as a liquid crystal panel, CRT screen, plasma display, EL (electroluminescent) display, or projector shutter type display glasses and includes a variety of display formats, such as the common VGA format used in personal computer displays and the like and video formats used for televisions.

Next, the operations of the 3D image generation and display system according to the second embodiment will be described.

First, a 3D object generating process performed by the 3D object generators 71-73 will be described briefly. The 3D object generator 71 is identical to the 3D object generating means described in FIG. 1. The object 33 for which a 3D image is to be formed is placed on the turntable 31. The table rotation controller 36 regulates rotations of the turntable 31, while the digital camera 34 and lighting 35 are controlled to take sample photographs by the photographing means 37 against a single-color screen, such as a blue screen (the background panel 32) as the background. The successive image creating means 38 then performs a process to combine the sampled images. Based on the resulting composite image, the 3D object combining means 39 extracts silhouettes (contours) of the object and generates a 3D object using a silhouette method or the like to estimate the three-dimensional shape of the object. This method is performed using the following equation, for example.

$$\begin{matrix}Equation 1 & \\ P = [ \begin{matrix}{S}_{1} & {S}_{2} & ⋯ & {S}_{1 n} \\ {P}_{21} & {P}_{22} & ⋯ & {P}_{2 n} \\ ⋮ & ⋮ & ⋯ & ⋮ \\ {P}_{m1} & {P}_{m2} & ⋯ & {P}_{mn}\end{matrix} ] & ( 1 )\end{matrix}$$

Coordinate conversion (calibration) is performed using camera coordinates Pfp and world coordinates Sp of a point P to convert three-dimensional coordinates at vertices of the 3D images to the world coordinate system [x, y, z, r, g, b] . A variety of modeling programs are used to model the resulting coordinates. The 3D data generated from this process is saved in an image database (not shown).

The 3D object generator 72 is a system for capturing images of an object by placing a plurality of cameras around the object. For example, as shown in FIG. 6, six cameras (first through sixth cameras) are disposed around an object. A control computer obtains photographic data from the cameras via USB hubs and reproduces 3D images of the object in real-time on first and second projectors. The 3D object generator 72 is not limited to six cameras, but may capture images with any number of cameras. The system generates 3D objects in the world coordinate system from the plurality of overlapping photographs obtained from these cameras and falls under the category of image-based rendering (IBR). Hence, the construction and process of this system is considerably more complicated than that of the 3D object generator 71. As with the 3D object generator 71, the generated data is saved in the database.

The 3D object generator 73 focuses primarily on computer graphics modeling using modeling software, such as 3ds max and YAPPA 3D Studio that assigns “top,” “left,” “right,” “front,” “perspective,” and “camera” to each of four views in a divided view port window, establishes a grid corresponding to the vertices of the graphics in a display screen and models an image using various objects, shapes, and other data stored in a library. These modeling programs can combine computer graphics data with photographs or image data created with the 3D object generators 71 and 72. This combining can easily be implemented by adjusting the camera's angle of view, the aspect ratio for rendered images in a bitmap of photographic data and computer graphic data.

A camera (virtual camera) can be created at any point for setting or modifying the viewpoint of the combined scene. For example, to change the camera position (user's viewpoint) that is set to the front by default to a position shifted 30 degrees left or right, the composite image scene can be displayed at a position in which the scene has been shifted 30 degrees from the front by setting the coordinates of the camera angle and position using [X, Y, Z, w] . Further, virtual cameras that can be created include a free camera that can be freely rotated and moved to any position, and a target camera that can be rotated around an object. When the user wishes to change the viewpoint of a composite image scene or the like, the user may do so by setting new properties. With the lens functions and the like, the user can quickly change the viewpoint with the touch of a button by selecting or switching among a group of about ten virtual lenses from WIDE to TELE. Lighting settings may be changed in the same way with various functions that can be applied to the rendered image. All of the data generated is saved in the database.

Next, the process for generating left and right parallax images with the renderer and LR data (parallax images) generating means 75 will be described. LR data of parallax signals corresponding to the left and right eyes can be easily acquired using the camera position setting function of the modeling software programs described above. A specific example for calculating the camera positions for the left and right eyes in this case is described next with reference to FIG. 7. The coordinates of the position of each camera are represented by a vector normal to the object being modeled (a cellular telephone in this example), as shown in FIG. 7(a). Here, the coordinate for the position of the camera is set to O; the focusing direction of the camera to a vector OT; and a vector OU is set to the direction upward from the camera and orthogonal to the vector OT. In order to achieve a stereoscopic display with positions for the left and right eyes, the positions of the left and right eyes (L, R) is calculated according to the following equation 2, where θ is the inclination angle for the left and right eyes (L, R) and d is a distance to a convergence point P for a zero parallax between the left and right eyes.

$$\begin{matrix}Equation 2 & \\ \vert \vec{OR} \vert = \vert \vec{OL} \vert = d tan θ \\ \vec{OR} = \frac{\vec{OU} \times \vec{OT}}{\vert \vec{OU} \vert \cdot \vert \vec{OT} \vert} \cdot d tan θ \\ \vec{OL} = \frac{\vec{OT} \times \vec{OU}}{\vert \vec{OT} \vert \cdot \vert \vec{OU} \vert} \cdot d tan θ \\ Here , ( 0 < d , 0 ≦ θ < 180 〉 & ( 2 )\end{matrix}$$

The method for calculating the positions described above is not limited to this method but may be any calculating method that achieves the same effects. For example, since the default camera position is set to the front, obviously the coordinates [X, Y, Z, w] can be inputted directly using the method for studying the camera (virtual camera) position described above.

After setting the positions of the eyes (camera positions) found from the above-described methods in the camera function, the user selects “renderer” or the like in the tool bar of the window displaying the scene to convert and render the 3D scene as a two-dimensional image in order to obtain a left and right parallax image for a stereoscopic display.

LR data is not limited to use with composite image scenes, but can also be created for photographic images taken by the 3D object generators 71 and 72. By setting coordinates [X, Y, Z, w] for camera positions (virtual cameras) corresponding to positions of the left and right eyes, the photographic images can be rendered, saving image data of the object taken around the entire periphery to obtain LR data for left and right parallax images. It is also possible to create LR data from image data taken around the entire periphery of an object saved in the same way for a 3D object that is derived from computer graphics images and the like modeled by the 3D object generator 73. LR data can easily be created by rendering various composite scenes.

In the actual rendering process, coordinates for each vertex of polygons in the world coordinate system are converted to a two-dimensional screen coordinate system. Accordingly, a 3D/2D conversion is performed by a reverse conversion of equation 1 used to convert camera coordinates to three-dimensional coordinates. In addition to calculating the camera positions, it is necessary to calculate shadows (brightness) due to virtual light shining from a light source. For example, light source data Cnr, Cng, and Cnb accounting for material colors Mr, Mg, and Mb can be calculating using the following transformation matrix equation 3.

$$\begin{matrix}Equation 3 & \\ [ \begin{matrix}Cnr \\ Cng \\ Cnb\end{matrix} ] = [ \begin{matrix}Pnr & 0 & 0 \\ 0 & Png & 0 \\ 0 & 0 & Pnb\end{matrix} ] [ \begin{matrix}Mr \\ Mg \\ Mb\end{matrix} ] & ( 3 )\end{matrix}$$

Here, Cnr, Cng, Cnb, Pnr, Png, and Pnb represent the n^{th} vertex.

LR data for left and right parallax images obtained through this rendering process is generated automatically by calculating coordinates of the camera positions and shadows based on light source data. Various filtering processes are also performed simultaneously but will be omitted from this description. In the display device, an up/down converter or the like converts the image data to bit data and adjusts the aspect ratio before displaying the image.

Next, a method for automatically generating simple LR data will be described as another example of the present invention. FIG. 8 is an explanatory diagram illustrating a method of generating simple left and right parallax images. As shown in the example of FIG. 8, LR data of a character “A” has been created for the left eye. If the object is symmetrical left to right, a parallax image for the right eye can be created as a mirror image of the LR data for the left eye simply by reversing the LR data for the left eye. This reversal can be calculated using the following equation 4.

$$\begin{matrix}Equation 4 & \\ \vert {X}^{′} {Y}^{′} \vert = \vert XY \vert \times \vert \begin{matrix}Rx & 0 \\ 0 & Ry\end{matrix} \vert & ( 4 )\end{matrix}$$

Here, X represents the X coordinate, Y the Y coordinate, and X′ and Y′ the new coordinates in the mirror image. Rx and Ry are equal to −1. This simple process is sufficiently practical when there are few changes in the image data, and can greatly reduce memory consumption and processing time.

Next, an example of displaying actual 3D images on various display devices using the LR data found in the above process will be described.

For simplicity, this description will cover the case in which LR data is inputted into the conventional display device shown in FIG. 19 to display 3D images. The display device shown in FIG. 19 is a liquid crystal panel (LCD) used in a personal computer or the like and employs a VGA display system using a sequential display technique. FIG. 9 is a block diagram showing a parallax image signal processing circuit. When LR data automatically generated according to the present invention is supplied to this type of display device, the LR data for both left and right parallax images shown in FIGS. 20(a) and 20(b) is inputted into a compressor/combiner 80. The compressor/combiner 80 rearranges the image data with alternating R and L data, as shown in FIG. 20(c), and compresses the image in half by skipping pixel, as shown in FIG. 20(d). A resulting LR composite signal is inputted into a separator 81. The separator 81 performs the same process in reverse, rearranging the image data by separating the R and L rows, as shown in FIG. 20(c). This data is uncompressed and expanded by expanders 82 and 83 and supplied to display drivers to adjust the aspect ratios and the like. The drivers display the L signal to be seen only with the left eye and the R signal to be seen only with the right eye, achieving a stereoscopic display. Since the pixels skipped during compression are lost and cannot be reproduced, the image data is adjusted using interpolation and the like. This data can be used on displays in notebook personal computers, liquid crystal panels, direct-view game consoles, and the like. The signal format for the LR data in these cases has no particular restriction.

Web 3D authoring tools such as YAPPA 3D Studio are configured to convert image data to LR data according to a Java applet process. Operating buttons such as those shown in FIG. 10 can be displayed on the screen of a Web browser by attaching a tool bar file to one of Java applets, and downloading the data (3d scene data, Java applets, and HTML files) from a Web server to the Web browser via a network. By selecting a button, the user can manipulate the stereoscopic image displayed in the Web browser (a car in this case) to zoom in and out, move or rotate the image, and the like. The process details of the operations for zooming in and out, moving, rotating, and the like are expressed in a transformation matrix. For example, movement can be represented by equation 5 below. Other operations can be similarly expressed.

$$\begin{matrix}Equation 5 & \\ \vert {X}^{′} {Y}^{′} 1 \vert = \vert XY 1 \vert \times \vert \begin{matrix}1 & 0 & 0 \\ 0 & 1 & 0 \\ Dx & Dy & 1\end{matrix} \vert & ( 5 )\end{matrix}$$

Here, X′ and Y′ are the new coordinates, X and Y are the original coordinates, and Dx and Dy are the distances moved in the horizontal and vertical directions respectively.

Next, an example of displaying images on an interlaced type display, such as a television screen, will be described. Various converters are commercially sold as display means in personal computers and the like for converting image data to common TV and video images. This example uses such a converter to display stereoscopic images in a Web browser. The construction and operations of the converter itself will not be described.

The following example uses a liquid crystal panel (or a CRT screen or the like) as shown in FIG. 19 for playing back video signals. A parallax barrier, lenticular sheet, or the like for displaying stereoscopic images is mounted on the front surface of the display device. The display process will be described using the block diagram in FIG. 11 showing a signal processing circuit for parallax images. LR data for left and right parallax images, such as that shown in FIGS. 20(a) and 20(b) generated according to the automatic generating method of the present invention, is inputted into compressors 90 and 91, respectively. The compressors 90 and 91 compress the images by skipping every other pixel in the video signal. A combiner 92 combines and compresses the left and right LR data, as shown in FIGS. 20(c) and 20(d). A video signal configured of this combined LR data is either transferred to a receiver or recorded on and played back on a recording medium, such as a DVD. A separator 93 performs the same operation in reverse, separating the combined LR data into left and right signals, as shown in FIGS. 20(c) and 20(d). Expanders 94 and 95 expand the left and right image data to their original form shown in FIGS. 20(a) and 20(b). Stereoscopic images can be displayed on a display like that shown in FIG. 19 because the display data is arranged with alternating left video data and right video data across the horizontal scanning lines and in the order R, G, and B. For example, the R (red) signal is arranged as “R0 (for left) R0 (for right), R2 (for left) R2 (for right), R4 (for left) R4 (for right) . . . .” The G (green) signal is arranged as “G0 (left) G0 (right), G2 (left) G2(right), . . . .” The B (blue) signal is arranged as “B0 (left) B0 (right), B2 (left) B2 (right) . . . .” Further, a stereoscopic display can be achieved in the same way using shutter glasses, having liquid crystal shutters or the like, as the display device, by sorting the LR data for parallax image signals into an odd field and even field and processing the two in synchronization.

Next, a description will be given for displaying stereoscopic images on a projector used for presentations or as a home theater or the like.

FIG. 12 is a schematic diagram of a home theater that includes a projector screen 101, the surface of which has undergone an optical treatment (such as an application of a silver metal coating); two projectors 106 and 107 disposed in front of the projector screen 101; and polarizing filters 108 and 109 disposed one in front of each of the projectors 106 and 107, respectively. Each component of the home theater is controlled by a controller 103. If the projector 106 is provided for the right eye and the projector 107 for the left eye, the filter 109 is a type that polarizes light vertically, while the filter 108 is a type that polarizes light horizontally. The type of projector maybe a MLP (meridian lossless packing) liquid crystal projector using a DMD (digital micromirror device). The home theater also includes a 3D image recorder 104 that supports DVD or another medium (certainly the device may also generate images through modeling), and a left and right parallax image generator 105 for automatically generating LR data with the display drivers of the present invention based on 3D image data inputted from the 3D image recorder 104. The aspect ratio of the LR data generated by the left and right parallax image generator 105 is adjusted by a down converter or the like and provided to the respective left and right projectors 106 and 107. The projectors 106 and 107 project images through the polarizing filters 108 and 109, which polarize the images horizontally and vertically, respectively. The viewer puts on polarizing glasses 102 having a vertically polarizing filter for the right eye and a horizontally polarizing filter for the left eye. Hence, when viewing the image projected on the projector screen 101, the viewer can see stereoscopic images since images projected by the projector 106 can only be seen with the right eye and images projected by the projector 107 can only be seen with the left eye.

### INDUSTRIAL APPLICABILITY

By using a Web browser for displaying 3D images in this way, only an electronic device having a browser is required, and not a special 3D image displaying device, and the 3D images can be supported on a variety of electronic devices. The present invention is also more user-friendly, since different stereoscopic display software, such as a stereo driver or the like, need not be provided for each different type of hardware, such as a personal computer, television, game console, liquid panel display, shutter glasses, and projectors.

### BRIEF DESCRIPTION OF THE DRAWINGS

In the drawings:

FIG. 1 is a flowchart showing steps in a process performed by the 3D image generation and display system according to a first embodiment of the present invention;

FIG. 2 is a schematic diagram showing 3D object generating means of the 3D image generation and display system described in FIG. 1;

FIG. 3 is a flowchart that shows a process from generation of 3D objects to drawing and displaying of 3D scenes in a WEB browser.

FIG. 4 is a perspective view of a printer as an example of a 3D object;

FIG. 5 is a schematic diagram showing a 3D image generation and display system according to a second embodiment of the present invention;

FIG. 6 is a schematic diagram showing a 3D image generator of FIG. 5 having 2−n cameras;

FIG. 7 is an explanatory diagram illustrating a method of setting camera positions in the renderer of FIG. 5;

FIG. 8 is an explanatory diagram illustrating a process for creating simple stereoscopic images;

FIG. 9 is a block diagram of an LR data processing circuit in a VGA display;

FIG. 10 is an explanatory diagram illustrating operations for zooming in and out, moving, and rotating a 3D image;

FIG. 11 is a block diagram showing an LR data processing circuit of a video signal type display;

FIG. 12 is a schematic diagram showing a stereoscopic display system employing projectors;

FIG. 13(a) is a schematic diagram of a conventional 3D modeling display device;

FIG. 13(b) is an explanatory diagram illustrating the creation of slit images;

FIG. 14 is a block diagram showing a conventional 3D modeling device employing a plurality of cameras;

FIG. 15 is a schematic diagram of a conventional 3D image signal generator;

FIG. 16 is an explanatory diagram showing LR data for the signal generator of FIG. 15;

FIG. 17 is an explanatory diagram illustrating a process for compressing the LR data in FIG. 16;

FIG. 18 is an explanatory diagram showing a method of displaying LR data on the display device of FIG. 15;

FIG. 19 is a schematic diagram of another conventional stereoscopic image displaying device; and

FIG. 20 is an explanatory diagram showing LR data displayed on the display device of FIG. 19.

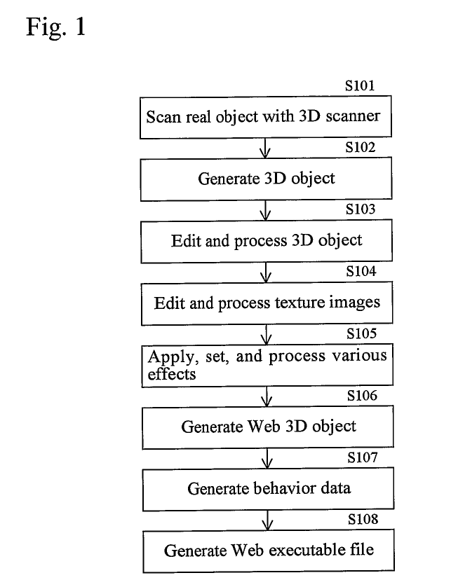

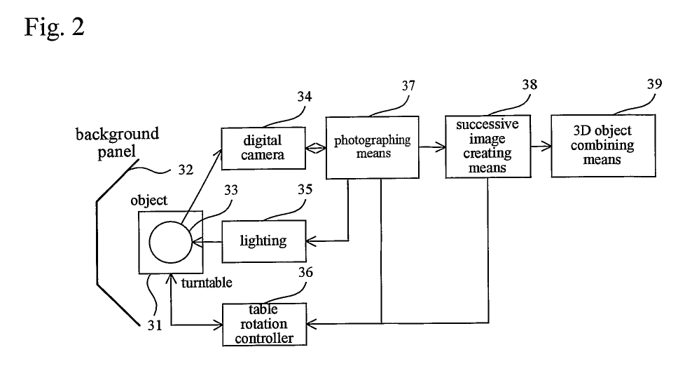

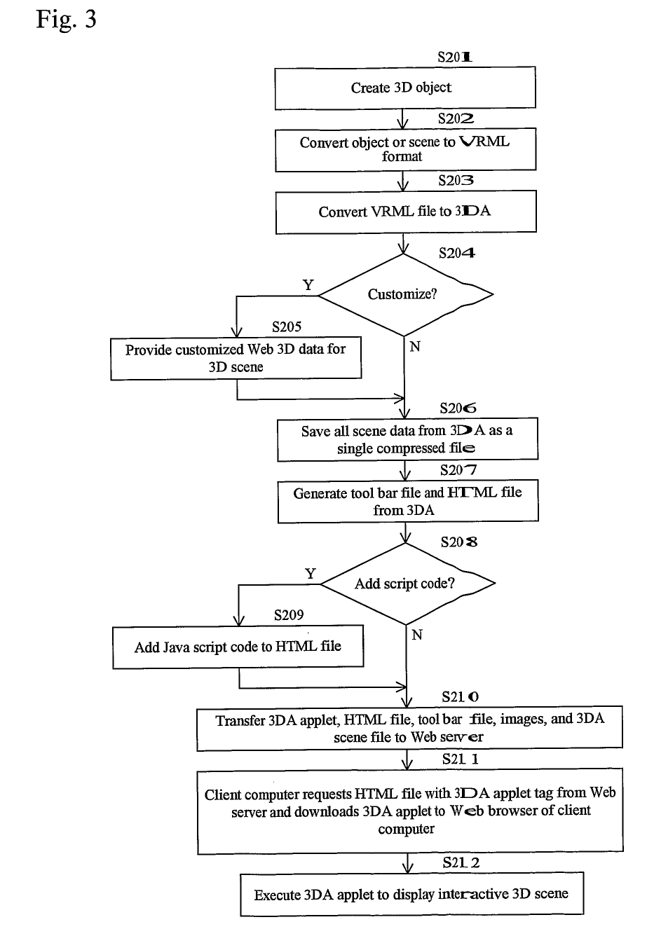

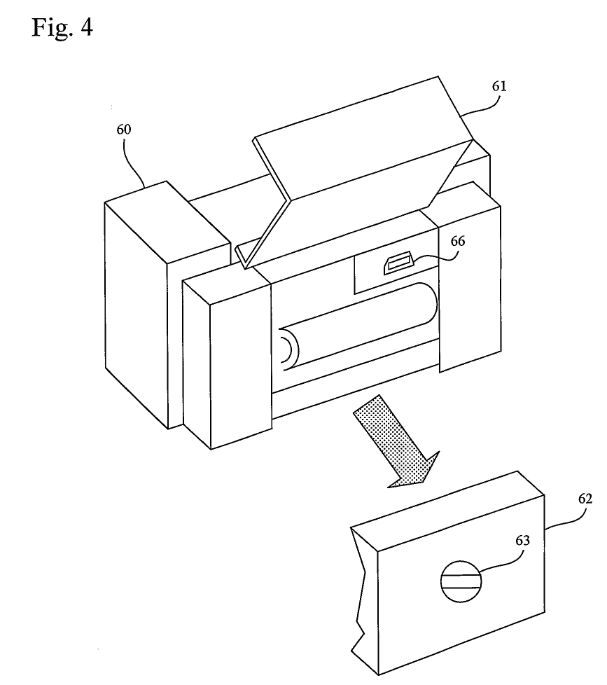

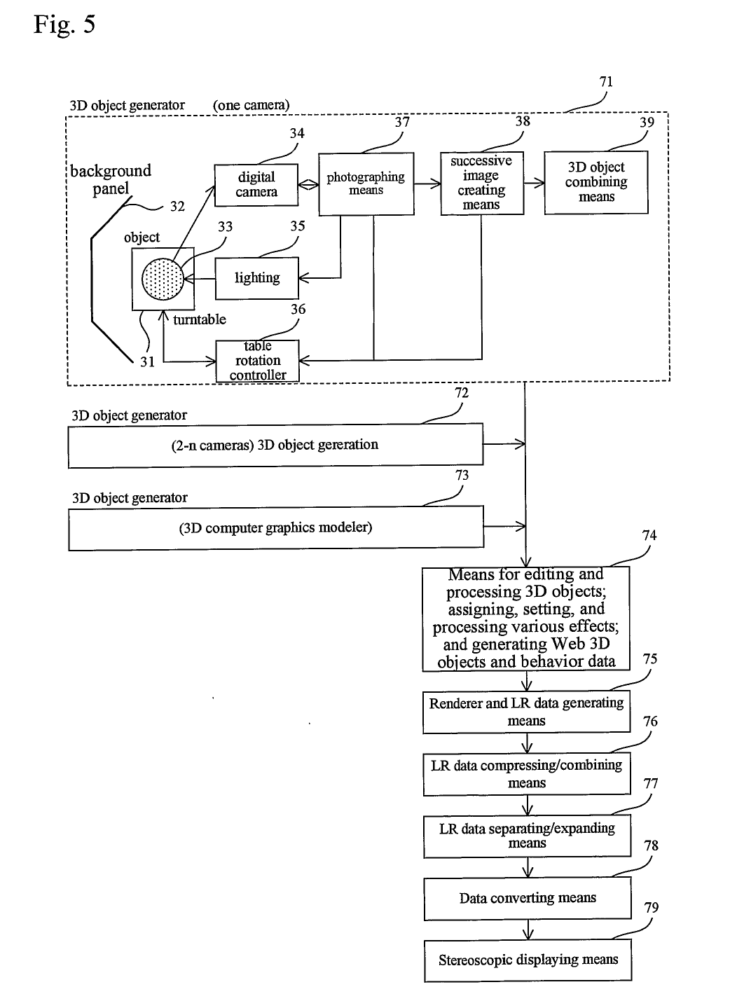

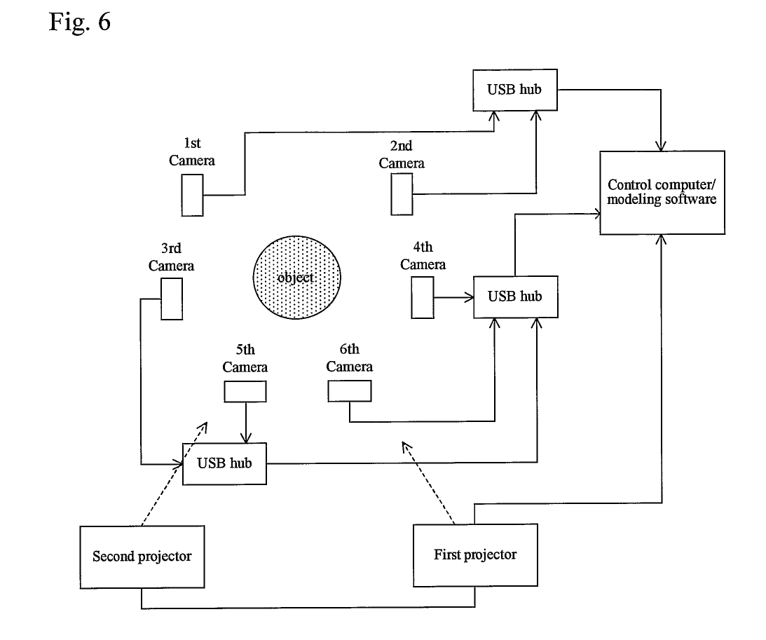

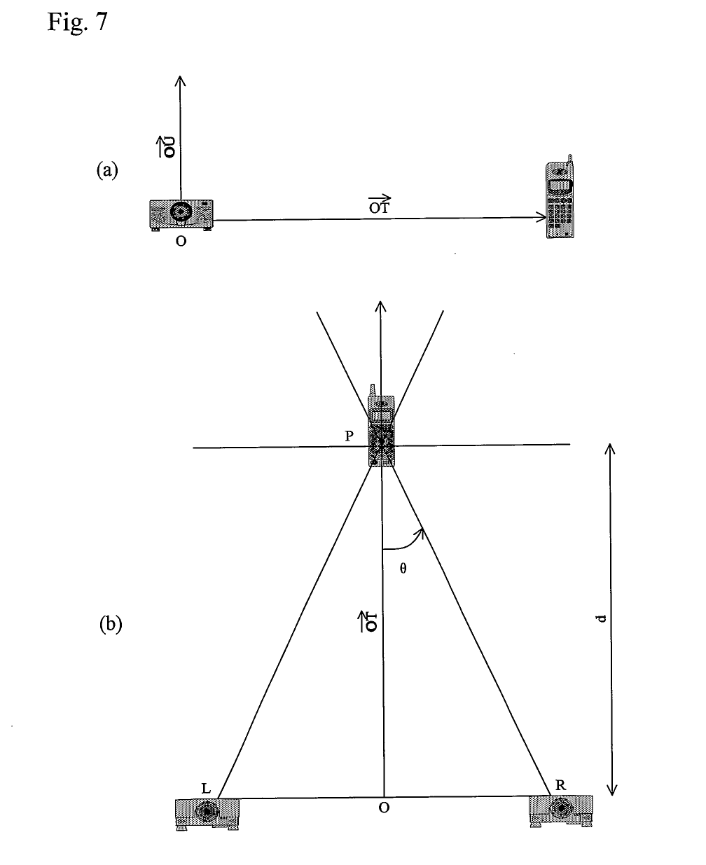

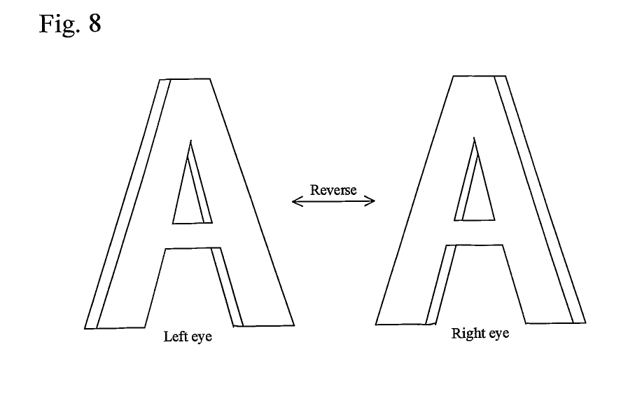

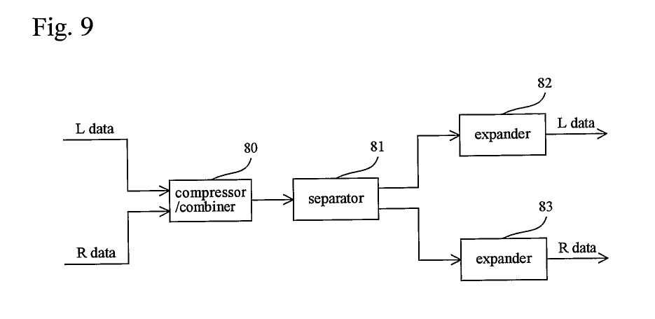

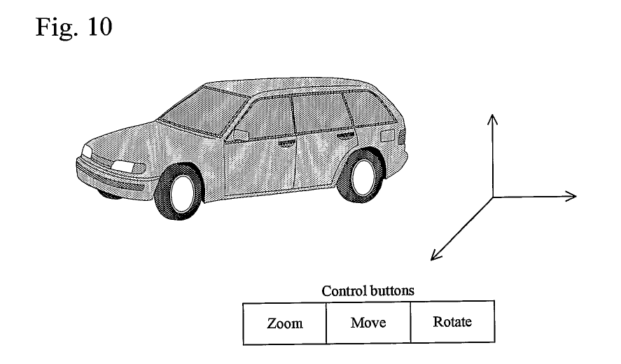

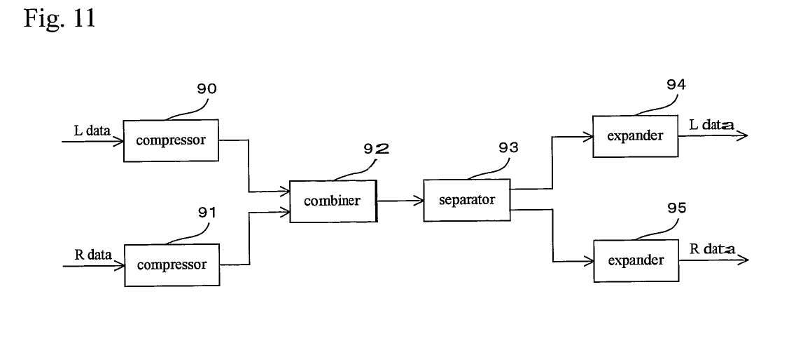

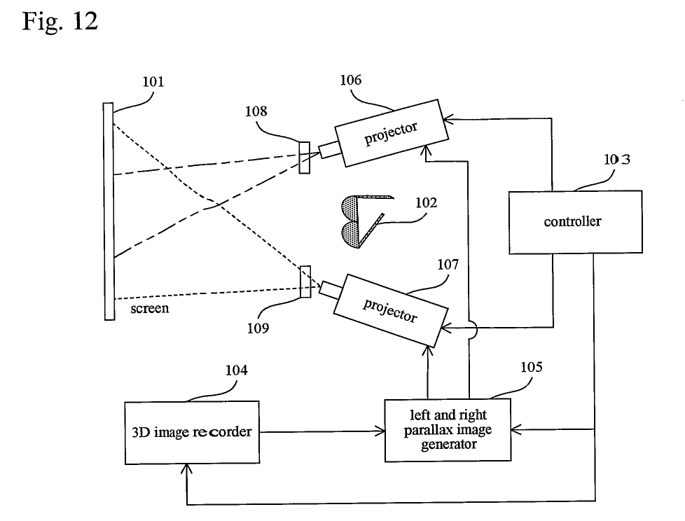

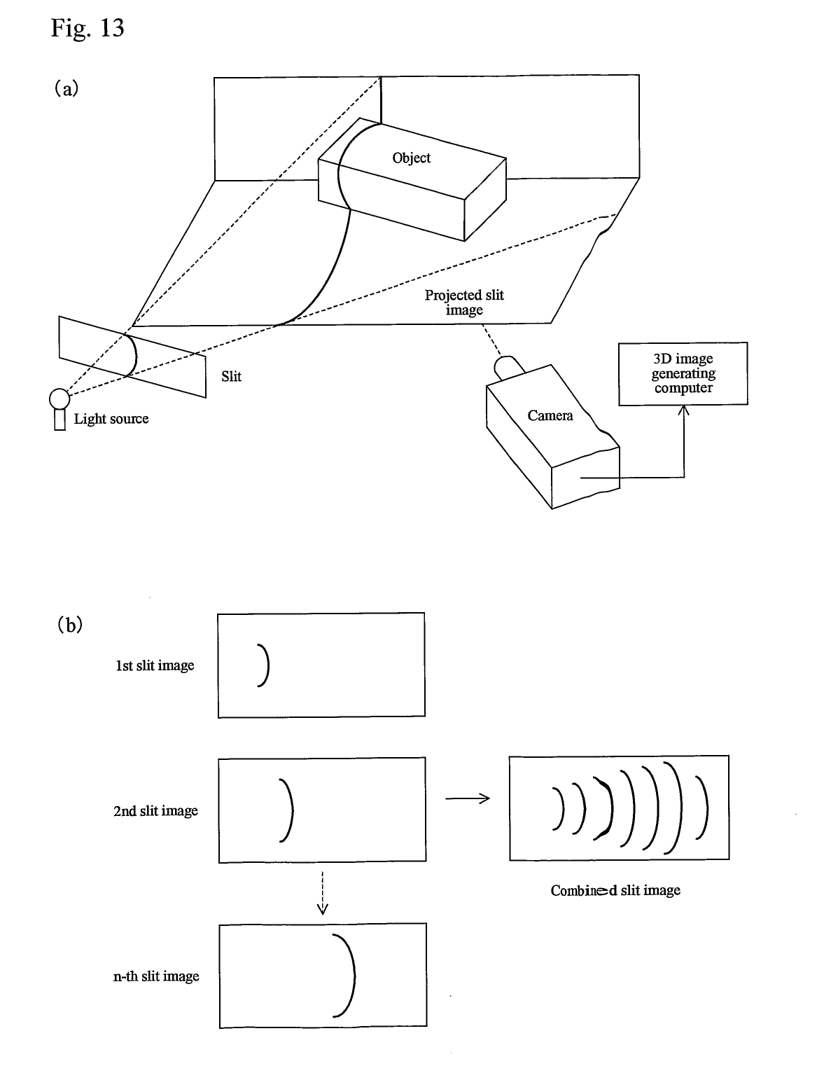

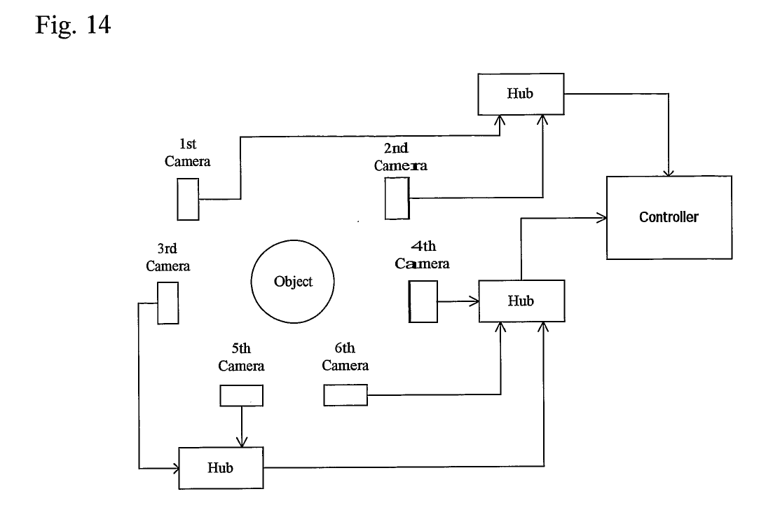

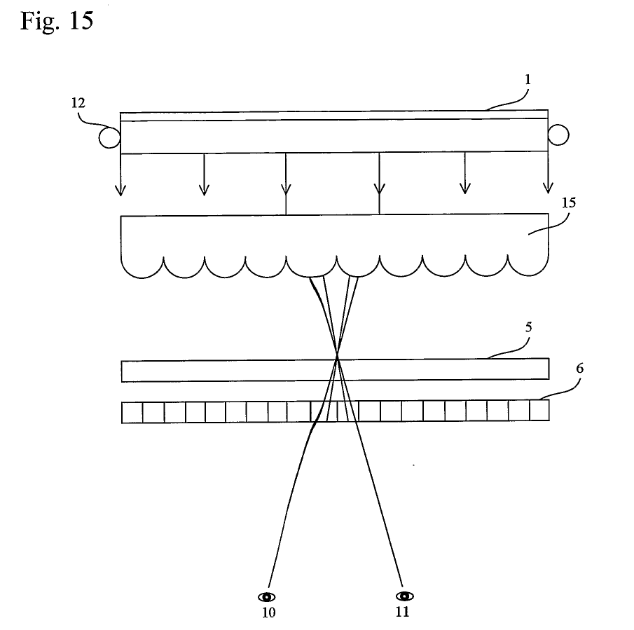

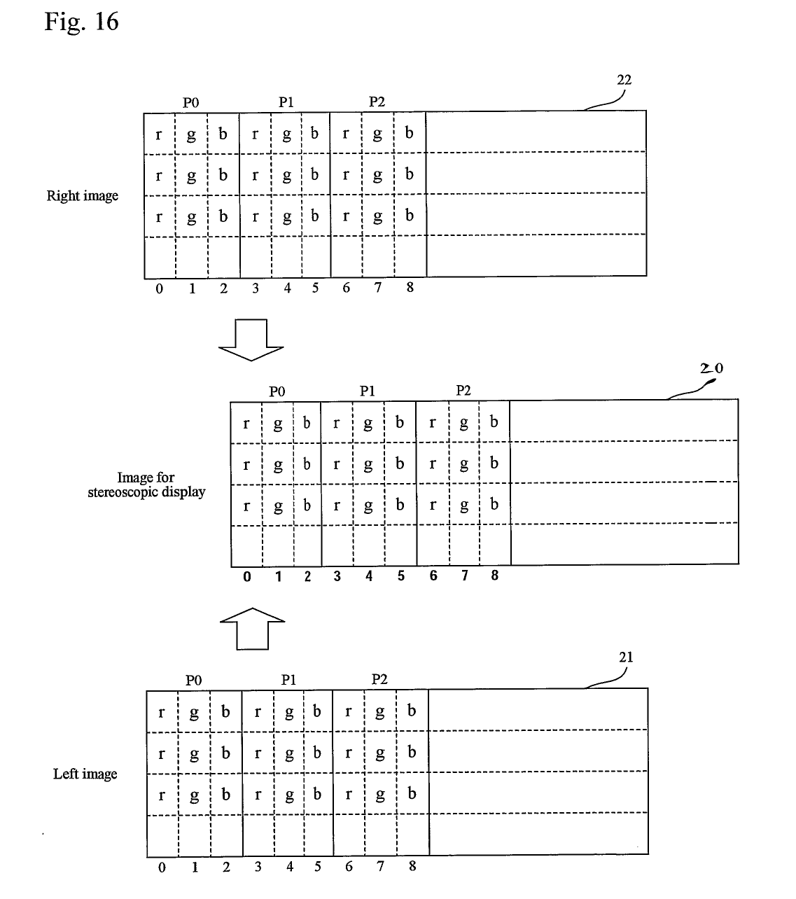

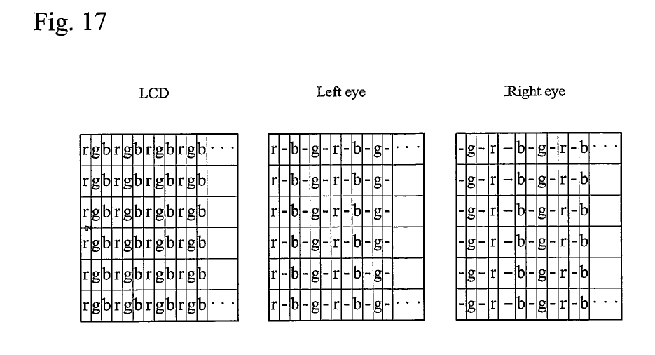

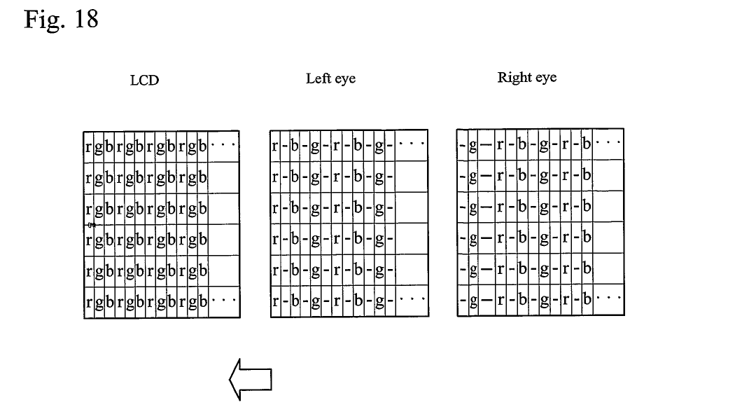

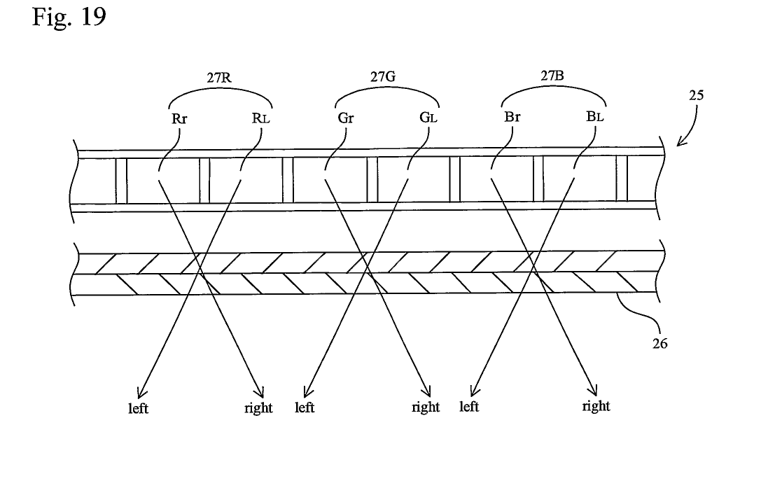

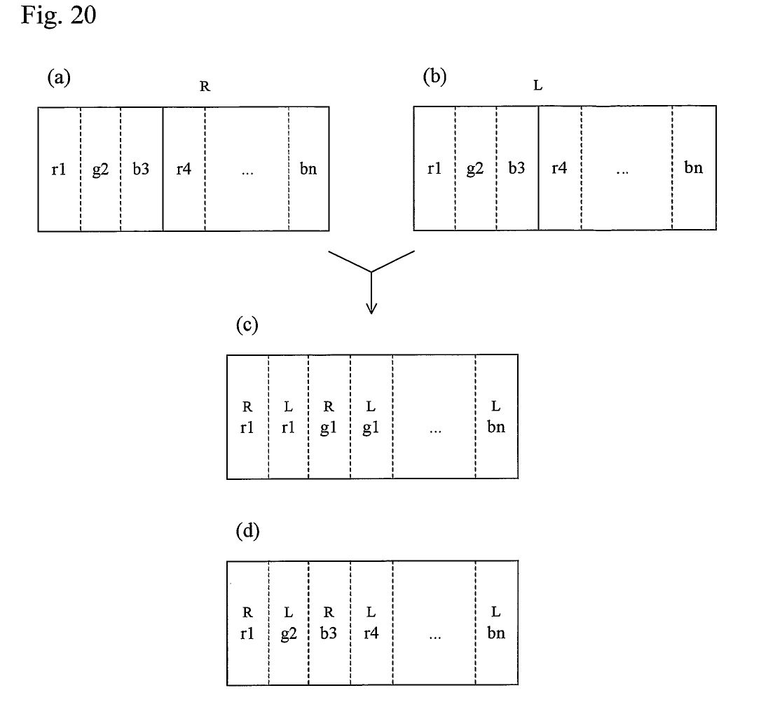

### DESCRIPTION OF THE REFERENCE NUMERALS AND SIGNS

1 backlight
5 diffuser
6,25 LCD
10 left eye
11 right eye
12 light source
15 lenticular lens
20 stereoscopic display image
21 left image
22 right image
26 parallax barrier
27R, 27G, 27B pixel group
31 turntable
32 background panel
33 object
34 digital camera
35 lighting
36 table rotation controller
37 photographing means
38 successive image creating means
39 3D object combining means
60 printer
61 top cover
62 cover
63 button
66 USB connector
71-73 3D object generators
75 renderer and LR data generating means
76 LR data compressing/combining means
77 LR data separating/expanding means
78 data converting means
79 stereoscopic displaying means
80 compressor/combiner
81, 93 separator
82, 83, 94, 95 expander
90, 91 compressor
92 combiner
102 polarizing glasses
103 controller (personal computer)
104 3D image recorder
105 left and right parallax image (LR data) generator
106, 107 projector
108, 109 polarizing filter

1. A 3D image generation and display system of using a computer system for generating three-dimensional (3D) objects used to display 3D images in a Web browser, the 3D image generation and display system comprising:
3D object generating means for creating 3D images from a plurality of different images and/or computer graphics modeling and generating a 3D object from these images that has texture and attribute data;
3D description file outputting means for converting the format of the 3D object generated by the 3D object generating means and outputting the data as a 3D description file for displaying 3D images according to a 3D graphics descriptive language;
3D object processing means for extracting a 3D object from the 3D description file, setting various attribute data, editing and processing the 3D object to introduce animation or the like, and outputting the resulting data again as a 3D description file or as a temporary file for setting attributes;
texture processing means for extracting textures from the 3D description file, editing and processing the textures to reduce the number of colors and the like, and outputting the resulting data again as a 3D description file or as a texture file;
3D effects applying means for extracting a 3D object from the 3D description file, processing the 3D object and assigning various effects such as lighting and material properties, and outputting the resulting data again as a 3D description file or as a temporary file for assigning effects;
Web 3D object generating means for extracting various elements required for rendering 3D images in a Web browser from the 3D description file, texture file, temporary file for setting attributes, and temporary file for assigning effects, and for generating various Web-based 3D objects having texture and attribute data that are compressed to be displayed in a Web browser;
behavior data generating means for generating behavior data to display 3D scenes in a Web browser with animation by controlling attributes of the 3D objects and assigning effects; and
executable file generating means for generating an executable file comprising a Web page and one or a plurality of programs including scripts, plug-ins, and applets for drawing and displaying 3D scenes in a Web browser with stereoscopic images produced from a plurality of combined images assigned with a prescribed parallax, based on the behavior data and the Web 3D objects generated, edited, and processed by the means described above.

2. The 3D image generation and display system according to claim 1, wherein the 3D object generating means comprises:
a turntable on which an object is mounted and rotated either horizontally or vertically;
a digital camera for capturing images of an object mounted on the turntable and creating digital image files of the images;
turntable controlling means for rotating the turntable to prescribed positions;
photographing means using the digital camera to photograph an object set in prescribed positions by the turntable controlling means;
successive image creating means for creating successively creating a plurality of image files using the turntable controlling means and the photographing means; and
3D object combining means for generating 3D images based on the plurality of image files created by the successive image creating means and generating a 3D object having texture and attribute data from the 3D images for displaying the images in 3D.

3. The 3D image generation and display system according to claim 2, wherein the 3D object generating means generates 3D images according to a silhouette method that estimates the three-dimensional shape of an object using silhouette data from a plurality of images taken by a single camera around the entire periphery of the object as the object is rotated on the turntable.

4. The 3D image generation and display system according to claim 1, wherein the 3D object generating means generates a single 3D image as a composite scene obtained by combining various image data, including images taken by a camera, images produced by computer graphics modeling, images scanned by a scanner, handwritten images, image data stored on other storage media, and the like.

5. The 3D image generation and display system according to claim 1, wherein the executable file generating means comprises:
automatic left and right parallax data generating means for automatically generating left and right parallax data for drawing and displaying stereoscopic images according to a rendering function based on right eye images and left eye images assigned a parallax from a prescribed camera position;
parallax data compressing means for compressing each of the left and right parallax data generated by the automatic left and right parallax data generating means;
parallax data combining means for combining the compressed left and right parallax data;
parallax data expanding means for separating the combined left and right parallax data into left and right sections and expanding the data to be displayed on a stereoscopic image displaying device; and
display data converting means for converting the data to be displayed according to the angle of view (aspect ratio) of the stereoscopic image displaying device.

6. The 3D image generation and display system according to claim 5, wherein the automatic left and right parallax data generating means automatically generates left and right parallax data corresponding to a 3D image generated by the 3D object generating means based on a virtual camera set by a rendering function.

7. The 3D image generation and display system according to claim 5, wherein the parallax data compressing means compresses pixel data for left and right parallax data by skipping pixels.

8. The 3D image generation and display system according to claim 5, wherein the stereoscopic display device employs at least one of a CRT screen, liquid crystal panel, plasma display, EL display, and projector.

9. The 3D image generation and display system according to claim 5, wherein the stereoscopic display device displays stereoscopic images that a viewer can see when wearing stereoscopic glasses or displays stereoscopic images that a viewer can see when not wearing glasses.

10. A 3D image generation and display system using a computer system for generating three-dimensional (3D) objects used to display 3D images in a Web browser, the 3D image generation and display system comprising:
a 3D object generator for creating 3D images from a plurality of different images and/or computer graphics modeling and generating a 3D object from these images that has texture and attribute data;
a 3D description file outputting for converting the format of the 3D object generated by the 3D object generator and outputting the data as a 3D description file for displaying 3D images according to a 3D graphics descriptive language;
a 3D object processor for extracting a 3D object from the 3D description file, setting various attribute data, editing and processing the 3D object to introduce animation or the like, and outputting the resulting data again as a 3D description file or as a temporary file for setting attributes;
a texture processor for extracting textures from the 3D description file, editing and processing the textures to reduce the number of colors and the like, and outputting the resulting data again as a 3D description file or as a texture file;
a 3D effects applicator for extracting a 3D object from the 3D description file, processing the 3D object and assigning various effects such as lighting and material properties, and outputting the resulting data again as a 3D description file or as a temporary file for assigning effects;
a web 3D object generator for extracting various elements required for rendering 3D images in a Web browser from the 3D description file, texture file, temporary file for setting attributes, and temporary file for assigning effects, and for generating various Web-based 3D objects having texture and attribute data that are compressed to be displayed in a Web browser;
a behavior data generator for generating behavior data to display 3D scenes in a Web browser with animation by controlling attributes of the 3D objects and assigning effects; and
an executable file generator for generating an executable file comprising a Web page and one or a plurality of programs including scripts, plug-ins, and applets for drawing and displaying 3D scenes in a Web browser with stereoscopic images produced from a plurality of combined images assigned with a prescribed parallax, based on the behavior data and the Web 3D objects generated, edited, and processed by the 3D image generation and display system.

11. The 3D image generation and display system according to claim 10, wherein the 3D object generator comprises:
a turntable on which an object is mounted and rotated either horizontally or vertically;
a digital camera for capturing images of an object mounted on the turntable and creating digital image files of the images;
turntable controlling means for rotating the turntable to prescribed positions;
photographing means using the digital camera to photograph an object set in prescribed positions by the turntable controlling means;
successive image creating means for creating successively creating a plurality of image files using the turntable controlling means and the photographing means; and
3D object combining means for generating 3D images based on the plurality of image files created by the successive image creating means and generating a 3D object having texture and attribute data from the 3D images for displaying the images in 3D.

12. The 3D image generation and display system according to claim 11, wherein the 3D object generating means generates 3D images according to a silhouette method that estimates the three-dimensional shape of an object using silhouette data from a plurality of images taken by a single camera around the entire periphery of the object as the object is rotated on the turntable.

13. The 3D image generation and display system according to claim 10, wherein the 3D object generating means generates a single 3D image as a composite scene obtained by combining various image data, including images taken by a camera, images produced by computer graphics modeling, images scanned by a scanner, handwritten images, and image data stored on other storage media.

14. The 3D image generation and display system according to claim 10, wherein the executable file generator comprises:
automatic left and right parallax data generating means for automatically generating left and right parallax data for drawing and displaying stereoscopic images according to a rendering function based on right eye images and left eye images assigned a parallax from a prescribed camera position;
parallax data compressing means for compressing each of the left and right parallax data generated by the automatic left and right parallax data generating means;
parallax data combining means for combining the compressed left and right parallax data;
parallax data expanding means for separating the combined left and right parallax data into left and right sections and expanding the data to be displayed on a stereoscopic image displaying device; and
display data converting means for converting the data to be displayed according to the angle of view (aspect ratio) of the stereoscopic image displaying device.

15. The 3D image generation and display system according to claim 14, wherein the automatic left and right parallax data generating means automatically generates left and right parallax data corresponding to a 3D image generated by the 3D object generating means based on a virtual camera set by a rendering function.

16. The 3D image generation and display system according to claim 14, wherein the parallax data compressing means compresses pixel data for left and right parallax data by skipping pixels.

17. The 3D image generation and display system according to claim 14, wherein the stereoscopic display device employs at least one of a CRT screen, liquid crystal panel, plasma display, EL display, and projector.

18. The 3D image generation and display system according to claim 14, wherein the stereoscopic display device displays stereoscopic images that a viewer can see when wearing stereoscopic glasses or displays stereoscopic images that a viewer can see when not wearing glasses.
